(19) United States
(12) Patent Application Publication
(10) Pub. No.: US 2005/0242075 A1
(43) Pub. Date: Nov. 3, 2005

(54) Method and apparatus for short circuit welding with pulse gas

(75) Inventors: Lori L. Kuiper, Fond du lac, WI (US); Richard M. Hutchison, New London, WI (US)

Correspondence Address: CORRIGAN LAW OFFICE, 5 BRIARCLIFF CT, APPLETON, WI, 54915, US

(73) Assignee: Illinois Tool Works Inc.

(21) Appl. No.: 11/175,594

(22) Filed: Jul. 5, 2005

Related U.S. Application Data
(63) Continuation of application No. 10/404,682, filed on Mar. 31, 2003.

(51) Int. Cl. B23K 9/06

(52) U.S. Cl. 219/130.4; 219/130.51

(57) ABSTRACT

A method and apparatus for short circuit welding, or a gas source therefor, includes providing a pulse gas to a welding location and initiating a short circuit welding process. The type of gas being provided is changed after the process has been established. Alternatively, it includes a gas source therefor, and further includes mixing at least two types of gas components and providing the mixture to a welding location, and initiating a short circuit welding process. The mixture is subsequently changed. The process can be a hybrid welding including providing short arc type welding power and intermittently providing pulse type welding power.

### FIELD OF THE INVENTION

The present invention relates generally to the art of welding More specifically, it relates to short circuit welding.

### BACKGROUND OF THE INVENTION

There are many types of welding power supplies and welding processes. One welding process is referred to as short circuit transfer welding. Short circuit transfer welding generally consists of alternating between an arc state and a short circuit, non-arc state. During the arc state the wire melts, and during the short circuit state the metal further melts and the molten metal is transferred from the end of the wire to the weld puddle. The metal transferred in one cycle is referred to herein as a drop, regardless of the size or shape of the portion of metal that is transferred.

Short circuit transfer welding has many advantages, such as shorter arc length and less melting of the base plate. However, short circuit transfer welding has disadvantages, such as increased spatter.

Both the power source topology and the control scheme must be considered when designing a short circuit transfer welding power source. The power topology used must be fast enough to have a timely response to the chosen control scheme. The control should address three considerations: First, arc length must be properly controlled. Second, the burn-off (or mass deposition) rate must be appropriately controlled. Inappropriate burn-off rate will result in increased spatter. Third, spatter is also caused by too much power when the short is cleared, i.e., the transition from a short circuit to an arc. Thus, the power or current when the short clears must also be controlled.

One prior art system that adequately address the many difficulties of short circuit welding was U.S. Pat. No. 6,087,626, Method and Apparatus for Welding Hutchison, et al., Jul. 11, 2000, hereby incorporated by reference. While that system performs much better than the prior art, it does not address controlling the gas supply to provide a better process.

In particular, at the start of the welding process the weld is cold. This leaves a sizeable nugget that needs to be ground out of the weld, or it will cause a discontinuity in the weld. The inventors have determined this may be avoided by controlling the gas supply. Accordingly, it is desirable to have a short circuit transfer welding process that controls the gas supply to help control the process.

### SUMMARY OF THE PRESENT INVENTION

According to a first aspect of the invention, a method and apparatus for short circuit welding, or a gas source therefor, includes providing a pulse gas to a welding location and initiating a short circuit welding process. The type of gas being provided is changed after the process has been established.

According to a second aspect of the invention, a method and apparatus for short circuit welding, or a gas source therefor, includes mixing at least two types of gas components and providing the mixture to a welding location, and initiating a short circuit welding process. The mixture is subsequently changed.

The gas provided after the change is short arc gas in one embodiment.

The gas mixture is controlled, such as altering a mix of active and inactive components, in response to start parameters in other embodiments.

The welding process is a hybrid pulse-short circuit process in another alternative.

According to a third aspect of the invention a method and apparatus for hybrid welding includes providing short arc type welding power and intermittently providing pulse type welding power.

The gas mixture is changed in conjunction intermittently providing pulse type welding power in one embodiment.

Other principal features and advantages of the invention will become apparent to those skilled in the art upon review of the following drawings, the detailed description and the appended claims.

### BRIEF DESCRIPTION OF THE DRAWINGS

FIG. 1 is a block diagram of a welding system in accordance with the present invention.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to it should be understood at the outset that it could be used with other systems as well. The system used in the preferred embodiment is similar to that of the '626 patent. However the power source used in the preferred embodiment is shown in U.S. Pat. No. 6,329,636, Method and Apparatus for Receiving a Universal Input Voltage in a Welding Plasma or Heating Power Source (hereby incorporated by reference). Source of power or power source, as used herein, includes the power circuitry such as rectifiers, switches, transformers, SCRs, etc that process and provide the output power.

The present invention provides for controlling the gas supplied to the weld, particularly at the start, to provide a more stable and robust process. More specifically, the process starts with a pulse gas, and then, after the arc is established, changes the gas mixture, preferably to a short-arc gas. The desired gasses may be provided using separate sources, and/or by varying the mixtures from common sources.

Pulse gas, as used herein, includes gasses typically used in a pulse process. One example is 95% Ar and 5% CO₂. Short arc gas, as used herein, includes a mixture of active ( e.g. CO₂ and O₂), and inactive gas components (e.g. inert gas components such as Ar, He, etc.) such that the percent of active gas components ranges from 0-100% for CO₂ (0-8% for O₂) and the remainder is inactive components. Establishing a process, as used herein, includes the start of a process and achieving pseudo-equilibrium in the arc. Pseudo-equilibrium for the arc, as used herein, includes establishing conditions in the weld (including the base material and weld puddle) that are substantially equal in temperature distribution to the steady state welding condition.

According to one embodiment, the gas supply is controlled in response to start parameters, preferably in response to detecting current and/or arc voltage. Start parameters, as used herein, includes parameters at the start of a welding process such as the type and duration of a mode, current, voltage, power, functions thereof, etc.

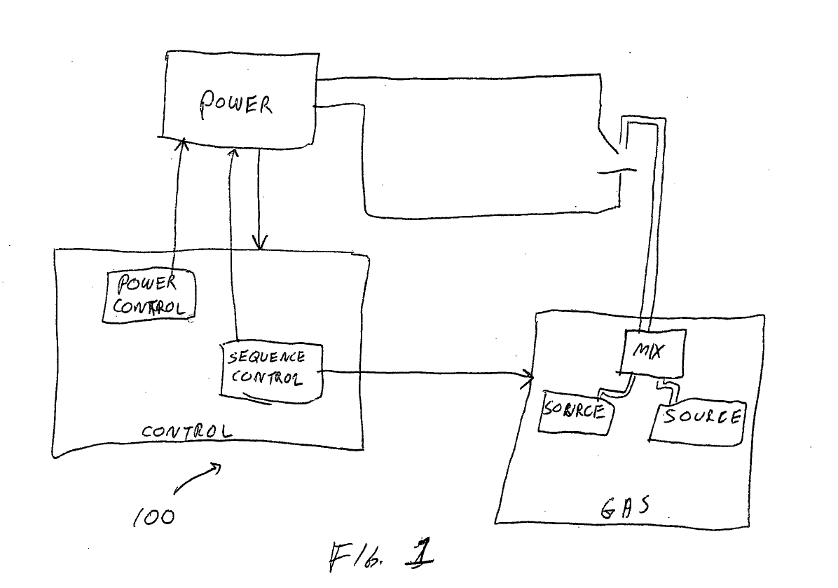

Turning now to FIG. 1, a block diagram of a welding system 100 includes, in accordance with the preferred embodiment a power source 103, a controller 105 and a source of gas 107 that cooperate to provide power and shielding gas to a welding location. Welding location, as used herein, includes the location, such as a spot or path. Controller 105 includes a start sequence controller 110 that controls gas source 107 in response to start parameter feedback. Start sequence controller, as used herein, includes a controller that controls the sequence of a start of a welding process, such as providing first pulse gas and then short arc gas.

Controller 105 also includes a power controller 112 that controls power source 103. Generally, power source 103 is controlled to provide power suitable for short circuit welding. However, in accordance with one embodiment of the invention power controller 112 controls power source 103 to provide pulse-type power on occasion or intermittently so that the output is a pulse output. Using such a hybrid pulse-short circuit process helps reinforce the root pass in the case of pipe joint welding. The gas mixture may be changed in conjunction with the power, or the gas may remain unchanged. Hybrid pulse-short circuit process, as used herein, includes a process that at times is a pulse process and at times a short circuit process. Pulse type power, as used herein, is power suitable for pulse welding.

Gas source 107 may include two sources of premixed gas, and a valve to select between them, and/or it may include a gas mixer 108, which combines desired amounts of various gasses in accordance with the control scheme.

Numerous modifications may be made to the present invention which still fall within the intended scope hereof. Thus, it should be apparent that there has been provided in accordance with the present invention a method and apparatus for welding that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method of short circuit welding, comprising:
providing a pulse gas to a welding location;
initiating a short circuit welding process; and
changing the type of gas provided after the process has been established.

2. The method of claim 1, wherein changing further comprises changing the type of gas provided to be short arc gas.

3. The method of claim 1, wherein providing a pulse gas further comprises controlling the gas mixture in response to start parameters.

4. The method of claim 1, further comprising controlling the gas mixture in response to start parameters.

5. The method of claim 4, further comprising providing pulse type power such that the welding process is a hybrid pulse-short circuit process.

6. The method of claim 1 wherein changing include altering the mixture of active and inactive components.

7. A short circuit welding power supply, comprising:
a source of pulse gas, disposed to provide gas to a welding location;
a source of second type of gas, disposed to provide gas to the welding location;
a source of power suitable for short circuit welding;
a controller, operatively connected to the source of power, and further operatively connected to the source of pulse gas and the source of the second type of gas, and further including a start sequence controller wherein the start sequence controller activates the source of pulse gas prior to the welding process starting, and then activates the source of the second type of gas after the process is established.

8. The welding power supply of claim 7, wherein the second type of gas is short arc gas.

9. The welding power supply of claim 8, further comprising a gas mixer, connected to the source of pulse gas, the source of the second type of gas, and the controller, and further wherein the gas mixer is responsive to start parameters.

10. The welding power supply of claim 9, wherein the controller includes a pulse control module connected to the source of power such that the welding process is a hybrid pulse-short circuit process.

11. A short circuit welding power supply, comprising:
a source of active gas components;
a source of inactive gas components;
a gas mixer, connected to the source of active and the source of inactive gas components, and having a mix control input, and disposed to provide a gas to welding location having a mixture responsive to the mix control input; and
a controller, operatively connected to the source of power, and further including a start sequence controller wherein the start sequence controller has a gas control output connected to the mix control input.

12. The power supply of claim 11, wherein the controller includes a start parameter feedback, and is responsive thereto.

13. A short circuit welding gas supply, comprising:
a source of active gas components;
a source of inactive gas components;
a gas mixer, connected to the source of active and the source of inactive gas components, and having a mix control input, and disposed to provide a gas to welding location having a mixture responsive to the mix control input; and
a controller, operatively connected to the source of active gas and the source of inactive gas, and further including a start sequence controller wherein the start sequence controller has a gas control output connected to the mix control input.

14. The power supply of claim 12, wherein the controller includes a start parameter feedback, and is responsive thereto.

15. A system for short circuit welding, comprising:
means for providing a pulse gas to a welding location;
means for initiating a short circuit welding process at the welding location; and
means for changing the type of gas provided after the process has been established, connected to the means for providing.

16. The system of claim 15, wherein the means for providing further comprises means for controlling the gas mixture in response to start parameters.

17. The system of claim 15, further comprising means for providing pulse type power to the weld location.

18. The system of claim 15 wherein the means for changing includes means for altering the mixture of active and inactive components.

19. A short circuit welding power supply, comprising:
means for providing a source of pulse gas to a welding location;
means for providing a second type of gas to the welding location;
means for providing power suitable for short circuit welding to the welding location; and
means for activating the source of pulse gas prior to the welding process starting, and then activating the source of the second type of gas after the process is established, operatively connected to the source of power, and further operatively connected to the source of pulse gas and the source of the second type of gas, and further including a start sequence controller wherein the start sequence.

20. The power supply of claim 19, wherein the second type of gas is short arc gas.

21. The welding power supply of claim 9, further comprising a pulse power source, disposed to provide power to the weld, such that the welding process is a hybrid pulse-short circuit process.

22. A short circuit welding power supply, comprising:
means for providing active gas components;
means for providing inactive gas components;
means for mixing gas, connected to the means for providing active and inactive gas components in response to a mix control input; and
means for controlling the means for mixing to first provide one mixture, and then provide another mixture, connected to the mix control input.

23. The power supply of claim 22, wherein the means for controlling includes a start parameter feedback, and is responsive thereto.

24. A short circuit welding gas supply, comprising:
means for providing active gas components;
means for providing inactive gas components;
means for mixing gas, connected to the means for providing active and inactive gas components in response to a mix control input; and
means for controlling the means for mixing to first provide one mixture, and then provide another mixture, connected to the mix control input.

25. The power supply of claim 24, wherein the means for controlling includes a start parameter feedback, and is responsive thereto.

26. A method of hybrid welding, comprising:
providing short arc type welding power; and
intermittently providing pulse type welding power.

27. The method of claim 26, further comprising adjusting a gas mixture in conjunction with intermittently providing pulse type welding power.

28. A system for of hybrid welding, comprising:
a source of short arc type welding power;
a source of pulse type welding power; and
a controller, including an intermittent selection circuit, connected to the source of short arc type welding power and the source of pulse type welding power.

29. The system of claim 28, further comprising an adjustable source of gas connected to the controller.

30. A system for hybrid welding, comprising:
means for providing short arc type welding power; and
means for intermittently providing pulse type welding power, connected to an output of the for providing short arc type welding power.

31. The system of claim 30, further comprising means for adjusting a gas mixture in conjunction with the means for intermittently providing pulse type welding power.

32. A system for of hybrid welding, comprising:
first power means for proving short arc type welding power to a weld;
second power means for providing pulse type welding power; and
means for intermittently and temporarily activating the second power means and deactivating the first power means, connected to the first and second power means.

33. The system of claim 32, further comprising means for adjusting a gas mixture in conjunction with the means for intermittently and temporarily activating the second power means and deactivating the first power means.
